(19) United States
(12) Patent Application Publication
(10) Pub. No.: US 2017/0270470 A1
(43) Pub. Date: Sep. 21, 2017

(54) METHOD AND DEVICE FOR HANDLING ALLOCATION REQUEST

(71) Applicant: ALIBABA GROUP HOLDING LIMITED, Grand Cayman (KY)

(72) Inventors: YANG YANG, HANGZHOU (CN); YUEYANG CHEN, HANGZHOU (CN)

(21) Appl. No.: 15/457,749

(22) Filed: Mar. 13, 2017

(30) Foreign Application Priority Data
Mar. 15, 2016 (CN) 201610146166.3

(51) Int. Cl. G06Q 10/08

(52) U.S. Cl. CPC G06Q 10/087

(57) ABSTRACT

A method for handling an allocation request is disclosed. The method may comprise issuing an allocation request to a warehouse management system (WMS) and instructing a transportation management system (TMS) to coordinate with the WMS to handle the allocation request, in response to determining that the WMS accepts the allocation request.

### CROSS REFERENCE TO RELATED APPLICATION

The present application is based on and claims the benefit of priority to Chinese Application No. 201610146166.3, filed on Mar. 15, 2016, the entire contents of which are incorporated herein by reference.

### TECHNICAL FIELD

The present invention relates to the field of Internet, and particularly to a method and device for handling an allocation request.

### BACKGROUND

Since most merchants often cannot transport goods to regional warehouses of a warehouse division sales system, a goods collection warehouse can be used for collecting goods near the merchants in order to improve the warehousing efficiency. A warehouse management system (WMS) is an information system for managing various warehouse operations. A transportation management system (TMS) mainly functions as the management of a transportation link among logistics links, including but not limited to the vehicle management and the goods management during transportation. A warehouse center (WHC) is a system for interacting with a warehouse and storing warehouse order data in a network system. Moreover, in view of interaction between the network system and various cooperative partners (CPs), a programmable automatic control (PAC) provides a unified mode of interaction with the CPs, thereby reducing the development cost of interaction between internal and external systems.

In the current technology, if a merchant needs to replenish goods through a goods collection warehouse, it needs to order a goods collection warehouse service and reserve warehousing. If the merchant needs to accomplish a warehousing reservation operation in the goods collection warehouse, firstly, the merchant has to pre-order the goods collection warehouse service, and then a logistics execution platform (LEP) system sets the storage space of the goods collection warehouse for the merchant; secondly, to execute the warehousing reservation, the merchant needs to have a replenishment plan order; and finally, the merchant fills in the warehousing reservation information, and orders the goods collection warehouse service. Meanwhile, the warehouse's receiving capability, and remaining capacity, and the remaining category capacity of the merchant all need to meet the reservation requirement for the reserved date(s). When all the above conditions are satisfied, the LEP system requests the warehouse center to generate a warehousing reservation order, and keeps the order number of the generated warehousing reservation. In addition, the LEP system supports the merchant to execute an amendment operation, if the capacity and the goods receiving capability of the warehouse and the remaining capacity of the merchant are sufficient. After the warehousing reservation of the goods collection warehouse is successfully accomplished, the merchant can arrange off-line delivery to the goods collection warehouse.

After the merchant stores goods into the goods collection warehouse by executing the above warehousing reservation operation, the goods can be sold to customers in all regions by reallocation to regional warehouses for temporarily storage before delivery. However, the allocation flow of the goods collection warehouse system is greatly different from that of the regional warehouse system, and needs coordination of the TMS because the allocation of the goods involves trunk transportation (i.e., transportation among cities).

Under the precondition (i.e., a condition to be satisfied for allocating goods from the goods collection warehouse to a regional warehouse) that the merchant orders the goods collection warehouse service and the LEP system sets outbound allocation from the goods collection warehouse to the regional warehouse for the merchant (that is, the direction of allocating goods from the warehouse to the outside is outbound, while the direction of allocating goods from the outside to the warehouse is inbound), the flow by which the merchant executes goods allocation in the goods collection warehouse system may include the following logics:

(1) Order Combination Handling Logic

Replenishment plan orders generated by a planning system are based on routes and goods dimensions. That is, a replenishment plan can be generated for the same commodity on the same route, and the merchant can submit the replenishment plans in batch to execute the goods allocation replenishment operation.

After the merchant submits the replenishment plans in batch and before the real allocation is initiated, the system combines the allocations of different commodities on the same trunk of the merchant into a handling process of an allocation request, thereby reducing the quantity of allocation orders and facilitating tracking by the merchant.

(2) Checking Logic Before Allocation

A) The merchant has ordered the goods collection warehouse.

B) The transportation capability of the trunk is sufficient.

C) At the estimated warehousing date, the current capacity and the goods receiving capability of the regional warehouse as well as the remaining warehouse capacity of the merchant need to satisfy specific conditions, and the estimated warehousing date can be calculated based on the date of initiating an allocation order and the efficiency of the trunk. It should be noted that the estimated warehousing date mentioned herein is not necessarily the real warehousing date. So the checking results of the warehouse capacity and the goods receiving capability may lose effect. That is, although the check may pass based on the estimated date, the real execution date off-line may be inconsistent with the estimated date. Further, the warehouse capacity and the goods receiving capability on the real execution date may be insufficient. Thus, the service party needs to provide a service handling scheme.

D) Checking the quantity of minimum inventory units in the current allocation order

For example, in order to realize standard commercialization management, space occupied by one model of refrigerators can be marked as a minimum inventory unit. Before goods are allocated, it needs to firstly confirm whether the quantity of the minimum inventory units is sufficient for the goods to be allocated. If five refrigerators of a certain model need to be allocated, and if the quantity of minimum inventory units is six at present, it indicates that the current allocation will succeed; however, if five refrigerators of the same model need to be allocated, but the quantity of minimum inventory units is four at present, it indicates that the current allocation will fail.

(3) Warehouse Interaction Logic

After the warehouse capacity and the warehouse receiving capability are determined, and if the check before allocation passes, the LEP creates a warehousing reservation order to request the WHC to execute allocation, and the warehousing reservation order may include at least one of the following items: a coordinative management main order, a transportation management plan order, and transportation management plan commodity details. In view of asynchrony of requesting warehousing and requesting a delivery coordination platform (DCP, mainly in charge of scheduling transportation for deliver goods among different cities), the transportation management plan order and the transportation management plan commodity details need to be persistently handled. That is, the order receiving state of a warehouse after the warehousing is requested needs to be asynchronously determined, and the DCP can be requested to issue a delivery instruction only when both the inbound and outbound warehouses of an allocation order receive the order.

When the LEP calls an allocation order creation interface of the WHC, it needs to transmit a special note to notify the WHC of the current trans-system allocation operation. Then, an allocation main order is created with a WHC operation logic. Meanwhile, a common warehouse outbound order and a purchase warehouse inbound order are separately issued to the goods collection warehouse and the RRS warehouse.

The WHC synchronously returns an allocation order creation result. If the creation fails, the current coordinative order is ended, and the warehouse capacity and the goods receiving capability are released; if the creation succeeds, relevant orders are updated, including: updating the state of the coordinative management main order, interpolating a coordinative management sub-order record, and interpolating a transportation scheduling task. The LEP monitors messages of various warehousing return records sent by the WHC (mainly including: monitoring a warehouse outbound message of the goods collection warehouse and a warehouse inbound message of the RRS warehouse), and updating corresponding coordinative main order and sub-order records.

(4) Delivery Interaction Logic:

When the transportation scheduling condition is satisfied, the LEP starts to request the DCP to execute trunk transportation.

The DCP issues a trunk transportation instruction, an execution result is synchronously returned, and the LEP interpolates the execution result into the transportation management sub-order record. The result returned by the DCP herein can only indicate completion of various checking logics of the DCP itself, but does not represent the handling state of the trunk; and the DCP asynchronously requests the trunk, and ensures successful interaction with the trunk via a reattempt mechanism.

For various states returned by the trunk, the DCP notifies the LEP; and the LEP updates the transportation main order and sub-orders according to the information of the message and additionally handles the following three types of messages at the same time:

1) order rejection messages returned by the trunk: the WHC is called to cancel allocation orders; such operation may occur when the transportation capability of the trunk is insufficient, and the occurrence probability is relatively small;

2) order allocation messages returned by the trunk: the LEP notifies the WHC to issue a delivery order, so that the warehouse and the trunk implement warehouse outbound move and reception operations according to the delivery order, which serves as a delivery voucher between the goods collection warehouse and the trunk; and

3) goods loss and damage messages returned by the trunk: the LEP records transportation abnormity logs, and updates the transportation management main order and sub-order information. Because the same transportation order trunk can operate and return multiple goods damage or loss messages, it should be noted that when using idempotence method for control, retransmitted messages and real goods loss and damage messages can be distinguished according to transportation order numbers and trunk return time.

In addition, situations such as damaged goods requiring to be returned from the regional warehouse to the goods collection warehouse may occur during trunk transportation. After the trunk returns goods damage information, the DCP sends the information to the LEP; and the LEP records a transportation abnormity log, and updates the information including goods damage quantity and the like in the transportation management sub-order. Then, the LEP calls the WHC to issue a trunk damaged goods return instruction to the goods collection warehouse, simultaneously updates the coordinative management sub-order, and increases a trunk damaged goods return record.

It should be noted that the trunk may return goods damage information for multiple times for one transportation order, and therefore, multiple trunk-returning warehouse inbound instructions need to be simultaneously issued.

It can be discovered from the above relevant operation flow introduction on the goods collection warehouse that the relevant technology has the following issues:

1) After the warehouse (of which its specific type is not limited herein) receives an issued allocation order, it may reject the order due to various problems inside the warehouse, and trunk delivery vehicles arriving at the warehouse docks need to wait for the goods to be retrieved from the warehouse and transported to the docks. Thus, the resources of the TMS vehicles are wasted, and the warehouse docks may become crowded and affect the delivery efficiency.

2) The warehouse needs to deliver goods on the allocation order after the trunk vehicles arrive, so the delivery efficiency is limited to a certain degree.

3) Because the WMS and the TMS lack effective indicator monitoring, the service performance quality of the WMS and the TMS cannot be checked.

4) The WMS is only in charge of reception and warehouse outbound, and the TMS is only in charge of trunk transportation management, so that account cross-checking is absent, and the accuracy of goods storage and transportation data cannot be guaranteed.

Effective solutions have not been put forward at present for at least one of the problems.

### SUMMARY

One aspect of the present disclosure is directed to a method for handling an allocation request. The method may comprise issuing an allocation request to a warehouse management system (WMS) and instructing a transportation management system (TMS) to coordinate with the WMS to handle the allocation request, in response to determining that the WMS accepts the allocation request.

Another aspect of the present disclosure is directed to a device for handling an allocation request. The device may comprise a first issuing module configured to issue an allocation request to a warehouse management system (WMS) and a handling module configured to instruct a transportation management system (TMS) to coordinate with the WMS to handle the allocation request, in response to determining that the WMS accepts the allocation request.

Another aspect of the present disclosure is directed to a non-transitory computer-readable storage media storing instructions that, when executed by a processor, cause the processor to perform a method for handling an allocation request. The method may comprise issuing an allocation request to a warehouse management system (WMS); and instructing a transportation management system (TMS) to coordinate with the WMS to handle the allocation request, in response to determining that the WMS accepts the allocation request.

Some embodiments of the present disclosure provide a method and device for handling an allocation request for at least solving the technical problem in the relevant technology that a TMS is instructed to coordinate with a WMS to handle an allocation request in the case where the handling result of the WMS on the allocation request is not acquired, so that resources are easily wasted.

According to some embodiments of the present disclosure, a method for handling an allocation request is provided, including the steps of: issuing an allocation request to a WMS; and determining whether a TMS is instructed to coordinate with the WMS to handle the allocation request according to the response result of the WMS on the allocation request.

Optionally, the step of determining whether a TMS is instructed to coordinate with the WMS to handle the allocation request according to the response result of the WMS on the allocation request includes at least one of the following modes: when confirming that the WMS accepts the allocation request according to the response result, instructing the TMS to coordinate with the WMS to handle the allocation request; and when confirming that the WMS rejects the allocation request according to the response result, canceling the allocation request.

Optionally, after confirming that the WMS accepts the allocation request according to the response result and instructing the TMS to coordinate with the WMS to handle the allocation request, the method further includes the steps of: receiving an order allocation message fed back by the TMS according to the allocation request and corresponding to a transportation tool, wherein the information carried in the order allocation message includes identification information of the transportation tool and a transportation task undertaken by the transportation tool; and issuing a delivery voucher to the WMS according to the order allocation message, wherein the delivery voucher is used for instructing the WMS to allocate corresponding goods according to the transportation task and determining whether the goods are delivered to the transportation tool according to a verification information set, and the verification information set at least includes the identification information of the transportation tool.

Optionally, after confirming that the WMS accepts the allocation request according to the response result and instructing the TMS to coordinate with the WMS to handle the allocation request, the method further includes the steps of: collecting a first monitoring indicator set returned by the WMS according to a preset cycle, wherein the first monitoring indicator set includes at least one of the following items: handling efficiency of the WMS on the allocation request, allocation efficiency of the WMS on goods, and fault frequency of the WMS; and under the condition that part of or all of indicators in the first monitoring indicator set do not satisfy preset conditions, sending prompt information to a client executing a monitoring operation on the first monitoring indicator set, wherein the prompt information is used for expressing that part of or all of indicators do not satisfy the preset conditions.

Optionally, after confirming that the WMS accepts the allocation request according to the response result and instructing the TMS to coordinate with the WMS to handle the allocation request, the method further includes the steps of: collecting a second monitoring indicator set returned by the TMS according to a preset cycle, wherein the second monitoring indicator set includes at least one of the following items: frequency of returning goods transportation information by the TMS, transportation damage rate of the TMS during transportation, and fault frequency of the TMS; and under the condition that part of or all of indicators in the second monitoring indicator set do not satisfy preset conditions, sending prompt information to a client executing a monitoring operation on the second monitoring indicator set, wherein the prompt information is used for expressing that part of or all of indicators do not satisfy the preset conditions.

Optionally, after confirming that the WMS accepts the allocation request according to the response result and instructing the TMS to coordinate with the WMS to handle the allocation request, the method further includes the steps of: separately acquiring first allocation data obtained when the TMS handles the allocation request and second allocation data obtained when the WMS handles the allocation request within a preset time range; and sending alarm information under the condition that the data difference between the first allocation data and the second allocation data exceeds a preset value range, wherein the alarm information is used for prompting that the first allocation data and/or the second allocation data are abnormal.

According to some embodiments of the present disclosure, further provided is a device for handling an allocation request, including: a first issuing module, used for issuing an allocation request to a WMS; and a handling module, used for determining whether a TMS is instructed to coordinate with the WMS to handle the allocation request according to the response result of the WMS on the allocation request.

Optionally, the handling module is used for, when confirming that the WMS accepts the allocation request according to the response result, instructing the TMS to coordinate with the WMS to handle the allocation request; or, when confirming that the WMS rejects the allocation request according to the response result, canceling the allocation request.

Optionally, the device further includes: a receiving module, used for receiving an order allocation message fed back by the TMS according to the allocation request and corresponding to a transportation tool, wherein the information carried in the order allocation message includes identification information of the transportation tool and a transportation task undertaken by the transportation tool; and a second issuing module, used for issuing a delivery voucher to the WMS according to the order allocation message, wherein the delivery voucher is used for instructing the WMS to allocate corresponding goods according to the transportation task and determining whether the goods are delivered to the transportation tool according to a verification information set, and the verification information set at least includes the identification information of the transportation tool.

Optionally, the device further includes: a first collection module, used for collecting a first monitoring indicator set returned by the WMS according to a preset cycle, wherein the first monitoring indicator set includes at least one of the following items: handling efficiency of the WMS on the allocation request, allocation efficiency of the WMS on goods, and fault frequency of the WMS; and a first monitoring module, used for, under the condition that part of or all of indicators in the first monitoring indicator set do not satisfy preset conditions, sending prompt information to a client executing a monitoring operation on the first monitoring indicator set, wherein the prompt information is used for expressing that part of or all of indicators do not satisfy the preset conditions.

Optionally, the device further includes: a second collection module, used for collecting a second monitoring indicator set returned by the TMS according to a preset cycle, wherein the second monitoring indicator set includes at least one of the following items: frequency of returning goods transportation information by the TMS, transportation damage rate of the TMS during transportation, and fault frequency of the TMS; and a second monitoring module, used for, under the condition that part of or all of indicators in the second monitoring indicator set do not satisfy preset conditions, sending prompt information to a client executing a monitoring operation on the second monitoring indicator set, wherein the prompt information is used for expressing that part of or all of indicators do not satisfy the preset conditions.

Optionally, the device further includes: an acquisition module, used for separately acquiring first allocation data obtained when the TMS handles the allocation request and second allocation data obtained when the WMS handles the allocation request within a preset time range; and a control module, used for sending alarm information under the condition that the data difference between the first allocation data and the second allocation data exceeds a preset value range, wherein the alarm information is used for prompting that the first allocation data and/or the second allocation data are abnormal.

In some embodiments of the present disclosure, determining whether the TMS is instructed to coordinate with the WMS to handle the allocation request according to the response result of the WMS on the allocation request is adopted, then the situation that the TMS is directly instructed to coordinate with the WMS to handle the allocation request in the case where the response result of the WMS on the allocation request is not acquired is avoided by waiting for the response result fed back by the WMS itself on the allocation request, and waste of TMS scheduling resources due to different response results of the TMS and the WMS on the allocation request is avoided, thereby achieving the technical effects of saving the TMS scheduling resources and improving the handover efficiency between the TMS and the WMS, and then solving the technical problem in the relevant technology that the TMS is instructed to coordinate with the WMS to handle the allocation request in the case where the handling result of the WMS on the allocation request is not acquired, so that resources are easily wasted.

It should be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 is a block diagram illustrating a hardware structure of a computer terminal, consistent with exemplary embodiments of the present disclosure.

FIG. 2 is a flow diagram illustrating a method for handling an allocation request, consistent with exemplary embodiments of the present disclosure.

FIG. 3 is a schematic diagram illustrating a system architecture of conveniently putting a product into a warehouse, consistent with exemplary embodiments of the present disclosure.

FIG. 4 is a flow diagram illustrating a method for handling an allocation request, consistent with exemplary embodiments of the present disclosure.

FIG. 5 is a flow diagram illustrating a method for issuing a delivery voucher to the WMS based on a returned allocation order of the TMS, consistent with exemplary embodiments of the present disclosure.

FIG. 6 is a flow diagram illustrating a method for reconciliation performed by comparing allocation data provided by the WMS and the TMS, consistent with exemplary embodiments of the present disclosure.

FIG. 7 is a structure block diagram illustrating a device for handling an allocation request, consistent with exemplary embodiments of the present disclosure.

FIG. 8 is a structure block diagram illustrating a device for handling an allocation request, consistent with exemplary embodiments of the present disclosure.

FIG. 9 is a structure block diagram illustrating a computer terminal, consistent with exemplary embodiments of the present disclosure.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

It should also be noted that the terms including “first”, “second” and the like in the descriptions, claims and accompanying drawings of the present disclosure are used for distinguishing similar objects, rather than describing specific sequences or priorities. It should be understood that the data can be exchanged when appropriate, so that the embodiments of the present disclosure described herein can be implemented in sequences other than those illustrated or described herein. Moreover, the terms “include”, “have” and any variant thereof are intended to cover non-exclusive inclusion, for example, the processes, methods, systems, products or devices including a series of steps or units are not limited to those steps or units listed clearly, but may include those not listed or other inherent steps or units of the processes, methods, products or devices.

According to the embodiments of the present disclosure, a method for handling an allocation request is disclosed. It should be noted that the steps shown in the flow diagrams of the accompanying drawings can be executed in a computer system comprising computer-executable instructions, and although the flow diagrams show logic sequences, the shown or described steps may be executed in sequences different from those described herein under certain conditions.

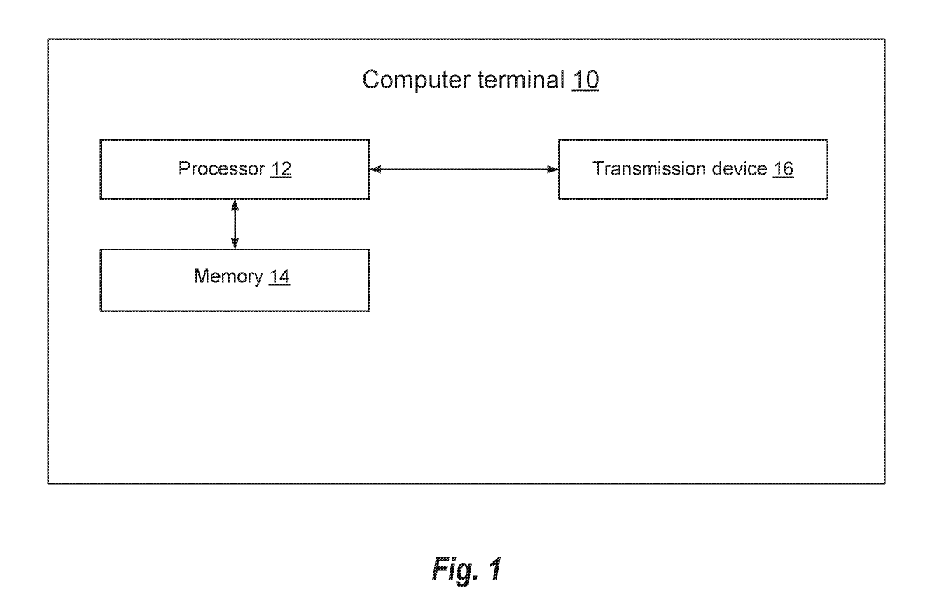

The method can be executed in a mobile terminal, a computer terminal, or a similar computing device. Taking the computer terminal as an example, FIG. 1 is a block diagram illustrating a hardware structure of a computer terminal 10 configured to implement the method for handling an allocation request, consistent with exemplary embodiments of the present disclosure. As shown in FIG. 1, the computer terminal 10 may include one or more (only one is shown in the figure) processors 12 (the processors 12 may include but not limited to processing devices such as micro control units (MCUs), field programmable gate arrays (FPGAs), or the like), a memory 14 for storing data, and a transmission device 16 for communication. Those of ordinary skill in the art could understand that the structure shown in FIG. 1 is only schematic, and does not limit the structure of the electronic device. For example, the computer terminal 10 may further include more or less components than those in FIG. 1, or have a configuration different from that shown in FIG. 1.

The memory 14 may be used for storing software programs and modules of application software, e.g., program instructions/modules corresponding to the method for handling an allocation request, and the processor 12 may execute the software programs and modules stored in the memory 14 to perform various functions and data handling, e.g., to implement the method for handling an allocation request. The memory 14 may include a high-speed random access memory or a nonvolatile memory, such as one or more magnetic storage devices, a flash memory, or other nonvolatile solid-state memory. In some embodiments, the memory 14 may further include memories arranged remotely relative to the processor 12, and these remote memories can be connected to the computer terminal 10 via a network. The examples of the network may include but not limited to Internet, intranets, local area networks, mobile communication networks, or a combination thereof.

The transmission device 16 is configured to receive or transmit data via a network. An example of the network may include a wireless network provided by a communication provider of the computer terminal 10. In one example, the transmission device 16 includes a network interface controller (NIC), which can be connected with other network equipment via a base station to communicate with the Internet. In another example, the transmission device 16 may be a radio frequency (RF) module, configured to communicate with the Internet wirelessly.

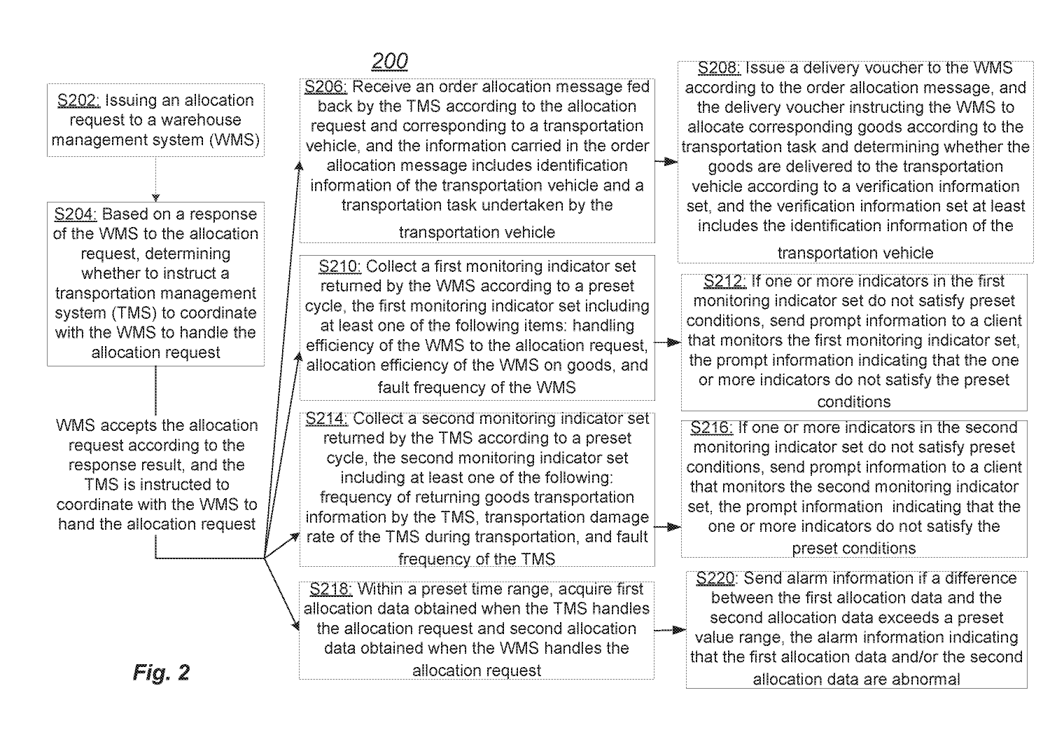

FIG. 2 is a flow diagram illustrating a method 200 for handling an allocation request, consistent with exemplary embodiments of the present disclosure. As shown in FIG. 2, method 200 may include the following steps:

Step S202: issuing an allocation request to a WMS. The allocation request may be issued to the WMS by an LEP in the form of an allocation order.

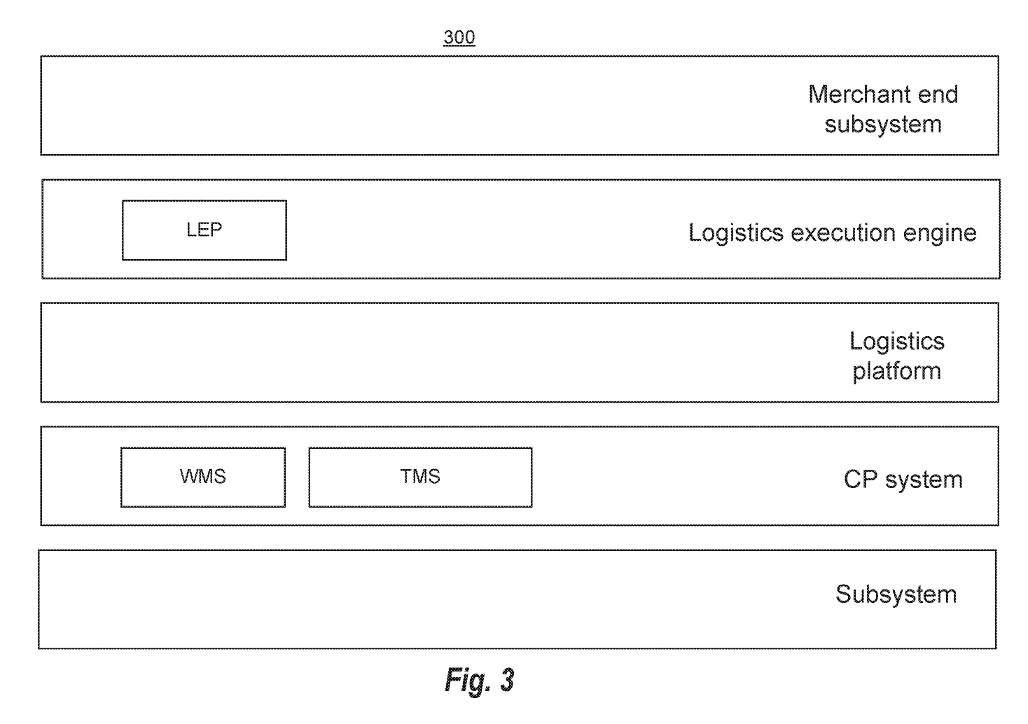

The system architecture for conveniently storing a product into a warehouse is introduced below referring to FIG. 3. FIG. 3 is a schematic diagram of a system architecture 300 for conveniently storing a product into a warehouse, consistent with exemplary embodiments of the present disclosure. As shown in FIG. 3, system 300 may comprise multiple layers. At the top are one or more merchant end subsystems directly carrying out information interaction with a merchant, and the merchant can set product parameters (e.g., allocation routes, and warehouses for goods collection) in the systems and initiate warehousing reservation and allocation. In addition, the merchant can also view a service panorama (overview) in the subsystems to learn the service execution conditions. The next layer is a logistics execution engine, e.g., LEP, and the subsystem is in charge of managing information such as capacity, receiving capability, routes, and the like of a warehouse, and coordinating the WMS and the TMS. The next layer includes one or more logistic platforms interacting with a CP system (e.g., WMS or TMS) and in charge of managing intra-warehouse operation and trunk operation, and one or more subsystems for directly executing practical operation by the CP and in charge of executing practical intra-warehouse operation and transportation trunk management.

Based on the schematic diagram of the system architecture shown in FIG. 3, in some embodiments, if the merchant needs to make a warehousing reservation, the following conditions are satisfied:

condition 1, when the merchant needs to order a goods collection warehouse service, the system automatically sets up goods collection warehouse capacity for the merchant;

condition 2, the merchant needs a replenishment plan order to execute the warehousing reservation; and

condition 3, when the merchant fills in warehousing reservation information and orders the goods collection warehouse service, it needs to be determined that the warehouse receiving capability, the remaining capacity of the warehouse, and the remaining category capacity of the merchant all meet the reservation requirement for the reserved date.

When all the above conditions are satisfied, the system (e.g., the LEP) requests a warehouse center to generate a warehousing reservation order, and keeps the order number of the warehousing reservation order after it is generated. In addition, the system supports the merchant to amend the order, if the capacity and the goods receiving capability of the warehouse and the remaining capacity of the merchant are sufficient. After the warehousing reservation operation in the goods collection warehouse is successfully accomplished, the merchant can arrange off-line delivery to the goods collection warehouse.

After the merchant stores goods into the goods collection warehouse by executing the above warehousing reservation operation, the merchant needs to allocate the goods in the goods collection warehouse to other warehouses to sell to customers. Since the allocation of the goods from collection warehouses involves trunk transportation, it needs coordination of the TMS while the allocation request is issued to the WMS.

Referring back to FIG. 2, method 200 may also comprise Step 204: based on the response of the WMS to the allocation request, determining whether to instruct a TMS to coordinate with the WMS to handle the allocation request.

In existing technologies, if the TMS is instructed to coordinate with the WMS to handle the allocation request when the handling responses of the WMS to the allocation request is not acquired, resources are easily wasted. Thus, as shown in FIG. 2, whether to instruct the TMS to coordinate with the WMS to handle the allocation request is determined based on the response of the WMS to the allocation request. As a result, a situation that the TMS is instructed to coordinate with the WMS to handle the allocation request in the case in absence of the response of the WMS to the allocation request can be avoided by waiting for the response fed back by the WMS to the allocation request. The waste of TMS scheduling resources due to different responses of the TMS and the WMS to the allocation request can be avoided, thereby saving the TMS scheduling resources and improving the handover efficiency between the TMS and the WMS.

Optionally, the step S204 may include at least one of the following modes:

mode I, when confirming that the WMS accepts the allocation request according to the response result, instructing the TMS to coordinate with the WMS to handle the allocation request. That is, only when the WMS is confirmed to accept the allocation request, the LEP instructs the TMS to coordinate with the WMS to handle the allocation request, thereby avoiding the waste of TMS scheduling resources when the LEP directly instructs the TMS to coordinate with the WMS to handle the allocation request without acquiring the response result of the WMS although the WMS rejects the allocation request; and

mode II, when confirming that the WMS rejects the allocation request according to the response result, canceling the allocation request. That is, when the WMS is confirmed to reject the allocation request, the LEP notifies the merchant in time that the allocation request is not accepted, so that the merchant can make an adjustment in time. Meanwhile, the TMS, which does not receive a coordination instruction from the LEP, will not blindly coordinate with the WMS to handle the allocation request and cause waste of TMS scheduling resources.

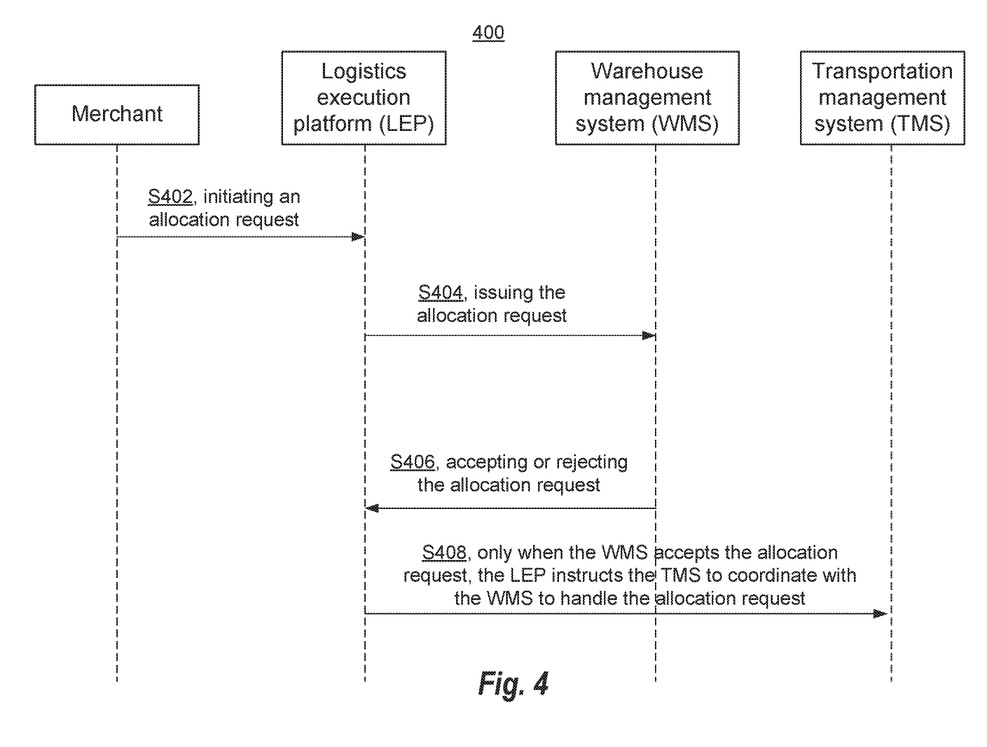

FIG. 4 is a flow diagram illustrating a method 400 for handling an allocation request, consistent with exemplary embodiments of the present disclosure. As shown in FIG. 4, method 400 may include the following steps:

Step S402: an LEP receives an allocation request (e.g., an allocation order) from a merchant;

Step S404: the LEP issues the allocation request to a WMS;

Step S406: the LEP receives a response message fed back by the WMS for accepting or rejecting the allocation request; and

Step S408: only when the response message indicates that the WMS accepts the allocation request, the LEP instructs the TMS to coordinate with the WMS to handle the allocation request, thereby ensuring that the warehouse executes the allocation request when a transportation vehicle allocated on a TMS trunk arrives at the warehouse managed by the WMS, preventing the waste of TMS vehicle resources in case that the warehouse rejects execution of the allocation request.

Compared with existing technologies in which the TMS is directly instructed to coordinate with the WMS to handle the allocation request without considering the response of the WMS to the allocation request, the technical solution disclosed herein has the advantages of improving the scheduling efficiency of the TMS and avoiding invalid transportation scheduling of the TMS by filtering allocation requests rejected by the WMS.

Optionally, after step S204 where the WMS accepts the allocation request according to the response result and the TMS is instructed to coordinate with the WMS to handle the allocation request, method 200 may further include the following steps:

Step S206: receiving an order allocation message fed back by the TMS according to the allocation request and corresponding to a transportation vehicle, the information carried in the order allocation message including identification information of the transportation vehicle and a transportation task (including, for example, the categories of goods undertaken by the transportation vehicle and the carrying capacity for each type of goods) undertaken by the transportation vehicle; and

Step S208: issuing a delivery voucher to the WMS according to the order allocation message, the delivery voucher instructing the WMS to allocate corresponding goods according to the transportation task and determining whether the goods are delivered to the transportation vehicle according to a verification information set, and the verification information set at least including the identification information of the transportation vehicle.

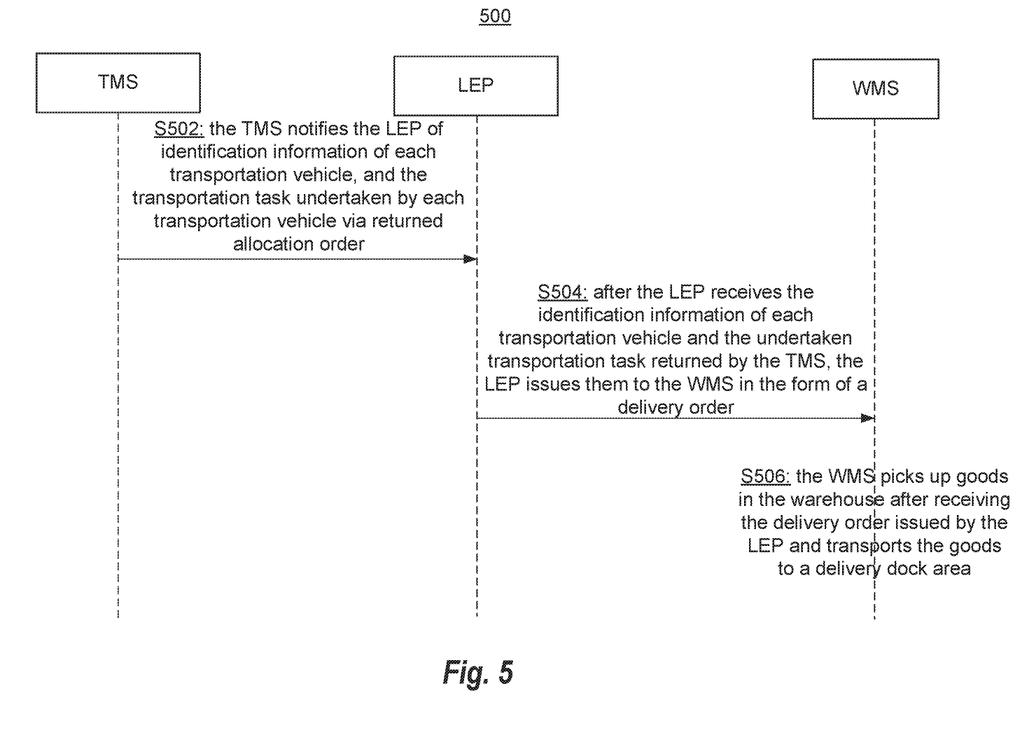

In one embodiment, a delivery order is used as the delivery voucher when the WMS and the TMS pick up goods. FIG. 5 is a flow diagram illustrating a method 500 for issuing a delivery voucher to the WMS based on a returned allocation order of the TMS, consistent with exemplary embodiments of the present disclosure. As shown in FIG. 5, method 500 may include the following steps:

Step S502: the TMS notifies the LEP of identification information (e.g., vehicle type, vehicle license plate number, vehicle owner name, and contact information) of each transportation vehicle, and the transportation task (e.g., loading M units of A type of goods, and loading N units of B type of goods) undertaken by each transportation vehicle via a returned allocation order;

Step S504: after the LEP receives the identification information of each transportation vehicle and the undertaken transportation task returned by the TMS, the LEP issues the identification information and the transportation task to the WMS in the form of a delivery order; and

Step S506: the WMS picks up goods in the warehouse after receiving the delivery order issued by the LEP and transports the goods to a delivery dock area, and then a trunk TMS vehicle arriving at the warehouse can directly pick up the goods, thereby avoiding the waste of vehicle resources and traffic block at the delivery dock area.

Compared with the existing technology, the disclosed embodiments have the following advantages. A premature delivery operation is avoided by performing warehouse outbound operation after trunk order allocation. In addition, the limited size of the dock area of the warehouse is considered, and the overall efficiency of the warehouse may be affected by piling too many goods in the dock area. On the other hand, the WMS can deliver goods to the TMS trunk vehicle according to the delivery order issued by the LEP, for example, the delivery can be performed only when multiple pieces of verification information including vehicle license plate number, vehicle contact information, order information, and the like are completely verified. As a result, the efficiency and the accuracy of handling the allocation request under the coordination of the TMS and the WMS are improved overall.

Optionally, after step S204 where the WMS accepts the allocation request according to the response result and the TMS is instructed to coordinate with the WMS to handle the allocation request, method 200 may further include the following steps:

Step S210: collecting a first monitoring indicator set returned by the WMS according to a preset cycle, the first monitoring indicator set including at least one of the following items: handling efficiency of the WMS to the allocation request, allocation efficiency of the WMS on goods, and fault frequency of the WMS; and

Step S212: if one or more indicators in the first monitoring indicator set do not satisfy preset conditions, sending prompt information to a client that monitors the first monitoring indicator set, the prompt information indicating that the one or more indicators do not satisfy the preset conditions.

In one embodiment, the convenient warehousing service includes WMSs of two CPs (i.e., the WMS of a regional warehouse system and the WMS of another regional warehouse system), and monitored indicators of the WMSs mainly include reception timeliness, dock efficiency, system fault rate, and the like. When receiving warehouse events such as a handling condition fed back by the WMS on the allocation request, a completion condition of delivery with the TMS and the like, the dedicated monitoring module in the LEP system comprehensively determines in combination with the order information provided by the merchant whether the preset conditions are satisfied. If the preset conditions are not satisfied (e.g., the handling efficiency of the WMS on the allocation request is lower than a first preset threshold, the allocation efficiency of the WMS on goods is lower than a second preset threshold, the fault frequency of the WMS is higher than a third preset threshold), the information is recorded in a database. Indicators not satisfying the preset conditions of the monitoring indicators periodically fed back by the WMS are repeatedly determined, till these indicators satisfy the preset conditions, thereby continuously improving the quality of service of the cooperative partner.

Optionally, after step S204 where the WMS accepts the allocation request according to the response result and TMS is instructed to coordinate with the WMS to handle the allocation request, method 200 may further include the following operations:

Step S214: collecting a second monitoring indicator set returned by the TMS according to a preset cycle, the second monitoring indicator set including at least one of the following: frequency of returning goods transportation information by the TMS, transportation damage rate of the TMS during transportation, and fault frequency of the TMS; and

Step S216: if one or more indicators in the second monitoring indicator set do not satisfy preset conditions, sending prompt information to a client that monitors the second monitoring indicator set, the prompt information indicating that the one or more indicators do not satisfy the preset conditions.

In one embodiment, the convenient warehousing service includes WMSs of two CPs (i.e., the WMS of a regional warehouse system and the WMS of another regional warehouse system), and monitored transportation events for the TMS mainly include trunk timeliness, transportation information return timeliness, transportation damage rate, system fault rate, and the like. When receiving the returned transportation information, and the TMS transportation arrival and transportation damage and loss messages fed back by the TMS, the dedicated monitoring module in the LEP system comprehensively determines in combination with the order information provided by the merchant whether the preset conditions are satisfied. If the preset conditions are not satisfied (e.g., the frequency of returning goods transportation information by the TMS is lower than a first preset threshold, the transportation damage rate of the TMS during transportation is higher than a second preset threshold, the fault frequency of the TMS is higher than a third preset threshold), the information is recorded in a database. Indicators not satisfying the preset conditions of the monitoring indicators periodically fed back by the WMS are repeatedly determined, till these indicators satisfy the preset conditions, thereby continuously improving the quality of service of the cooperative partner.

Compared with the existing technology, the disclosed embodiments improve the quality of service of the CP. After the convenient warehousing service is online, system instability is the most common problem indicated by merchant users. For example, the merchant cannot order or inquire an order, the data of the order is erroneous, and the like due to system faults may appear frequently. These problems may seriously affect the overall user experience of the product, so the usability of the CP system needs to be monitored, and a usability indicator of the system is used as an important part of a cooperation contract to improve the usability of the CP system. Moreover, high trunk transportation fault rate is also a problem complained frequently by merchant users, because the trunk only takes a part of compensation responsibility for trunk transportation damages, and the merchant may suffer a greater loss. If the trunk damage rate is too high, the profits of the merchant are reduced greatly. Therefore, the merchant experience can also be further improved by monitoring the trunk damage rate and requiring the CP to reduce the transportation damage rate via periodical feedback.

Optionally, after step S204 where the WMS accepts the allocation request according to the response result and the TMS is instructed to coordinate with the WMS to handle the allocation request, method 200 may further include the following steps:

Step S218: within a preset time range, acquiring first allocation data obtained when the TMS handles the allocation request and second allocation data obtained when the WMS handles the allocation request; and

Step S220: sending alarm information if a difference between the first allocation data and the second allocation data exceeds a preset value range, the alarm information indicating that the first allocation data and/or the second allocation data are abnormal.

In one embodiment, the WMS and the TMS cooperatively handle a large amount of allocation requests every day, and a merchant user can only inquire the storage data in the warehouse and relevant information of each allocation request. However, the merchant cannot intuitively learn relevant data of current goods in transportation, the time when the goods can arrive at the warehouse, etc. In addition, if the data provided by the WMS and the TMS are inconsistent, the merchant cannot know which data shall prevail. Since the inventory is the foundation of the business, lacking accurate, detailed, and intuitive data statistics will seriously affect the operation strategy of the merchant. Thus, a reasonable account checking mechanism is established, so that the WMS and the TMS can plan a comparison on inventory data provided by the two parties at every preset time length (e.g., at the same time every day). The inventory data may include but not limited to allocated orders and arriving allocation orders estimated according to the timeliness. The data is checked at the same time every day, offline intervention for reconciliation is needed if the data of account checking difference exceeds a certain value range, then alarm information can be sent to the merchant to prompt that the inventory data provided by the WMS and the TMS are greatly different and need to be reconciled. The merchant can operate according to reports of an inventory allocated today and an inventory to be allocated within future N days, and the WMS and the TMS can also be better coordinated by the LEP, so that the inventory accuracy of the WMS and the TMS is improved.

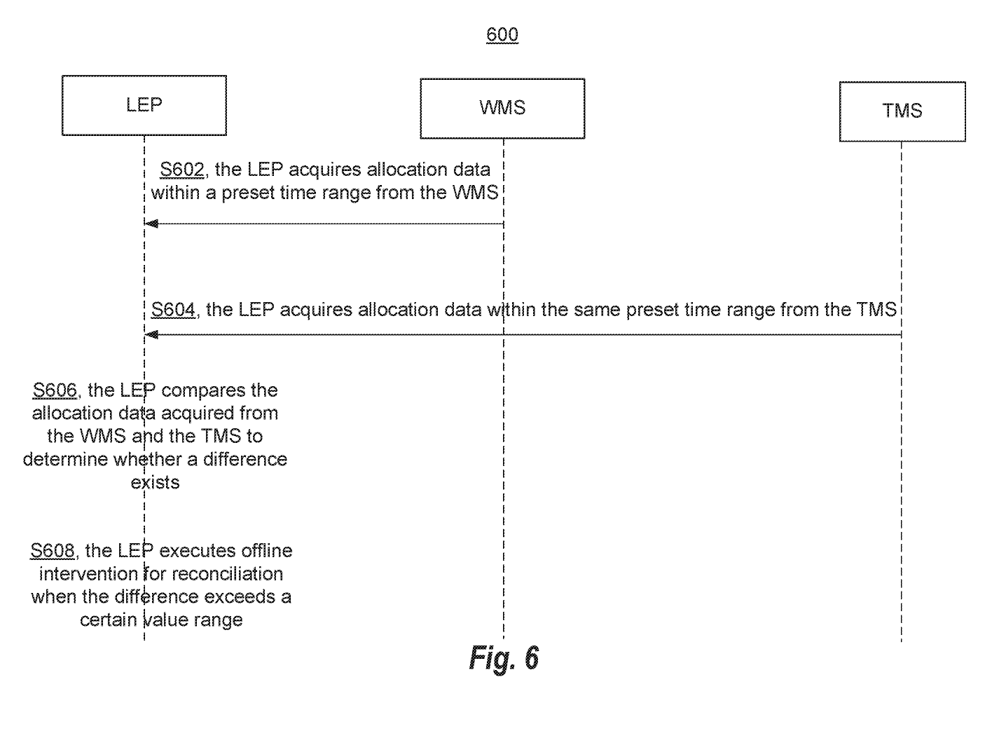

FIG. 6 is a flow diagram illustration a method 600 for reconciliation performed by comparing allocation data provided by the WMS and the TMS, consistent with exemplary embodiments of the present disclosure. As shown in FIG. 6, method 600 may include the following steps:

Step S602: the LEP acquires allocation data within a preset time range from the WMS;

Step S604: the LEP acquires allocation data within the same preset time range from the TMS;

Step S606: the LEP compares the allocation data acquired from the WMS and the TMS to determine whether a difference exists; meanwhile, the merchant can acquire reports of an inventory allocated today and an inventory to be allocated within future N days via the comparison; and

Step S608: the LEP executes offline intervention for reconciliation when the difference exceeds a certain value range.

Compared with the existing technology, the disclosed embodiments may enhance the data transparency and provide bases for merchant operation, since accurate data is the foundation for executing accurate decisions, and periodical data reconciliation can expose abnormal data in the system as early as possible. The disclosed embodiments may also provide accurate and valid data reports for the merchant, the LEP, the WMS, and the TMS, so that each party can better observe service data and make operation strategies.

It should be noted that the aforementioned method embodiments are described as a combination of a series of actions for the purpose of simplicity, but those skilled in the art should learn that the present disclosure is not limited by the described action sequences, because some steps can be performed in other sequences or simultaneously according to the present disclosure. In addition, those skilled in the art should also learn that the embodiments described in the specification are preferred embodiments, and the involved actions and modules are not always necessary for the present disclosure.

Based on the descriptions of the above embodiments, those skilled in the art could clearly learn that the method for handling an allocation request according to the above embodiments can be implemented by means of software and necessary hardware. It can also be implemented via hardware. Based on such an understanding, the technical solutions of the present disclosure substantially or the part of the present disclosure making contribution to the prior art may be embodied in the form of a software product, and the computer software product is stored in a storage medium (such as an ROM/RAM, a magnetic disk or an optical disk), which includes a plurality of instructions enabling terminal equipment (which may be a mobile phone, a computer, a server, network equipment or the like) to execute the method of each embodiment of the present disclosure.

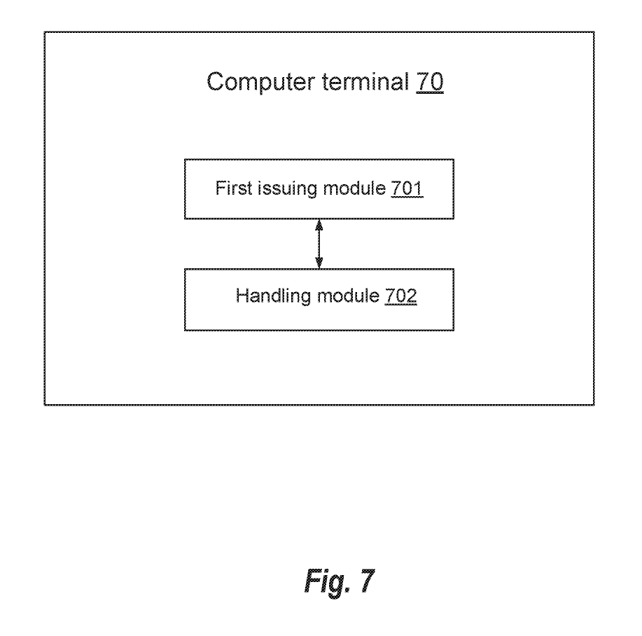

FIG. 7 is a structure block diagram of a device 70 for handling an allocation request, consistent with exemplary embodiments of the present disclosure. As shown in FIG. 7, the device 70 includes a first issuing module 701 and a handling module 702. The first issuing module 701 may be configured to issue an allocation request to a WMS, and the handling module 702 may be configured to determine whether a TMS is instructed to coordinate with the WMS to handle the allocation request according to the response of the WMS to the allocation request. The device 70 and the device 10 may be the same device, and the modules 701 and 702 may correspond to the processor 12 described above.

Optionally, the handling module 702 may be configured to, when confirming that the WMS accepts the allocation request according to the response result, instruct the TMS to coordinate with the WMS to handle the allocation request; or, when confirming that the WMS rejects the allocation request according to the response result, cancel the allocation request.

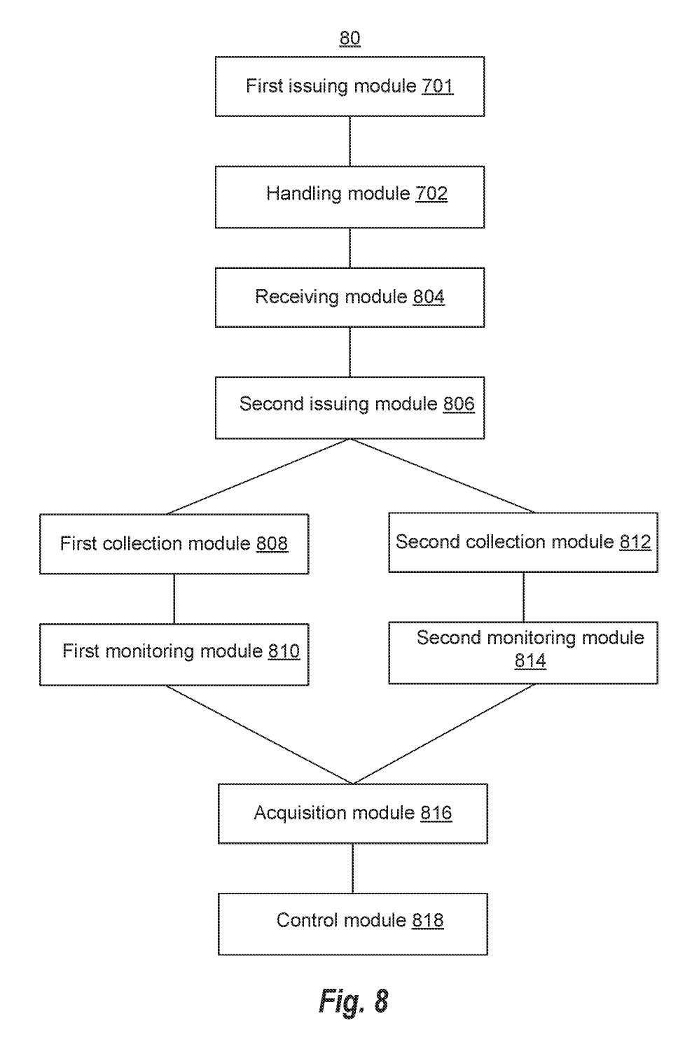

FIG. 8 is a structure block diagram of a device 80 for handling an allocation request, consistent with exemplary embodiments of the present disclosure. The device 80 may be a more detailed description of the device 70. As shown in FIG. 8, apart from the modules 701 and 702, the device 80 further includes: a receiving module 804 configured to receive an order allocation message fed back by the TMS according to the allocation request and corresponding to a transportation vehicle, the information carried in the order allocation message including identification information of the transportation vehicle and a transportation task undertaken by the transportation vehicle; and a second issuing module 806 configured to issue a delivery voucher to the WMS according to the order allocation message. The delivery voucher may comprise information or instructions that instruct the WMS to allocate corresponding goods according to the transportation task and determine whether the goods are delivered to the transportation vehicle according to a verification information set. The verification information set may at least include the identification information of the transportation vehicle.

Optionally, as shown in FIG. 8, the device further includes: a first collection module 808 configured to collect a first monitoring indicator set returned by the WMS according to a preset cycle, the first monitoring indicator set including at least one of the following items: handling efficiency of the WMS on the allocation request, allocation efficiency of the WMS on goods, and fault frequency of the WMS; and a first monitoring module 810 configured to, if one or more indicators in the first monitoring indicator set do not satisfy preset conditions, send prompt information to a client that monitors the first monitoring indicator set, the prompt information indicating that the one or more indicators do not satisfy the preset conditions.

Optionally, as shown in FIG. 8, the device further includes: a second collection module 812 configured to collect a second monitoring indicator set returned by the TMS according to a preset cycle, the second monitoring indicator set including at least one of the following: frequency of goods transportation information returned by the TMS, transportation damage rate of the TMS during transportation, and fault frequency of the TMS; and a second monitoring module 814 configured to, if one or more indicators in the second monitoring indicator set does not satisfy preset conditions, sending prompt information to a client that monitors the second monitoring indicator set, the prompt information indicating that the one or more indicators do not satisfy the preset conditions.

Optionally, as shown in FIG. 8, the device further includes: an acquisition module 816 configured to, within a preset time range, acquire first allocation data obtained when the TMS handles the allocation request and second allocation data obtained when the WMS handles the allocation request; and a control module 818 configured to send alarm information if a difference between the first allocation data and the second allocation data exceeds a preset value range, the alarm information prompting that the first allocation data and/or the second allocation data are abnormal.

A computer terminal, e.g., any computer terminal equipment in a computer terminal group, is disclosed consistent with exemplary embodiments of the present disclosure. Optionally, the computer terminal may also be terminal equipment such as a mobile terminal and the like.

Optionally, the computer terminal may be at least one of multiple pieces of network equipment in a computer network in some embodiments.

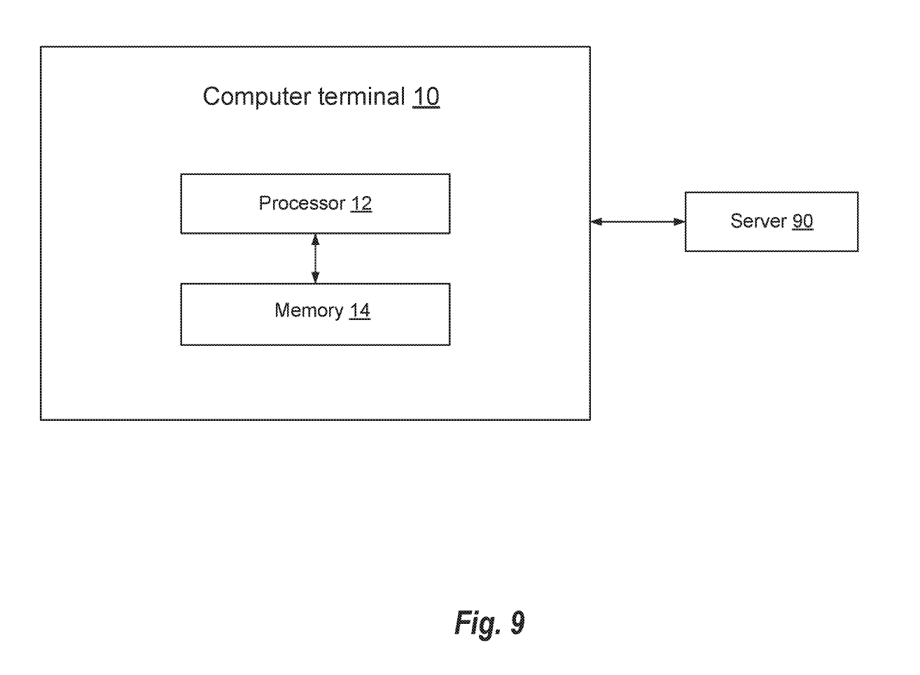

FIG. 9 is a structure block diagram illustrating a computer terminal 10, consistent with exemplary embodiments of the present disclosure. As shown in FIG. 9 and similar to FIG. 1, the computer terminal 10 may include one or more (though only one is shown in the figure) processors 12 and a memory 14. The computer terminal 10 may connect to a server 90.

The memory 14 may be configured to store software programs and modules, e.g., program instructions/modules corresponding to the method and device for handling an allocation request in the embodiments of the present disclosure, and the processor 12 runs the software programs and modules stored in the memory 14 to execute various function applications and data handling, namely to implement the method for handling an allocation request. The memory 14 may include a high-speed random access memory or a nonvolatile memory, such as one or more magnetic storage devices, a flash memory or other nonvolatile solid-state memory. In some examples, the memory 14 may further include memories arranged remotely relative to the processor 12, and these remote memories may be connected to the terminal via a network. The examples of the network include but not limited to Internet, intranets, local area networks, mobile communication networks and a combination thereof.

The processor 12 can call information and application programs stored by the memory 14 via the transmission device to execute the following steps:

S1, issuing an allocation request to a WMS; and

S2, determining whether a TMS is instructed to coordinate with the WMS to handle the allocation request according to the response of the WMS to the allocation request.

Optionally, the processor 12 may further execute program codes of the following steps: when confirming that the WMS accepts the allocation request according to the response result, instructing the TMS to coordinate with the WMS to handle the allocation request; and when confirming that the WMS rejects the allocation request according to the response result, canceling the allocation request.

Optionally, the processor 12 may further execute program codes of the following steps: receiving an order allocation message fed back by the TMS according to the allocation request and corresponding to a transportation vehicle, the information carried in the order allocation message including identification information of the transportation vehicle and a transportation task undertaken by the transportation vehicle; and issuing a delivery voucher to the WMS according to the order allocation message, the delivery voucher instructing the WMS to allocate corresponding goods according to the transportation task and determining whether the goods are delivered to the transportation vehicle according to a verification information set. The verification information set at least includes the identification information of the transportation vehicle.

Optionally, the processor 12 may further execute program codes of the following steps: collecting a first monitoring indicator set returned by the WMS according to a preset cycle, the first monitoring indicator set including at least one of the following items: handling efficiency of the WMS on the allocation request, allocation efficiency of the WMS on goods, and fault frequency of the WMS; and if one or more indicators in the first monitoring indicator set do not satisfy preset conditions, sending prompt information to a client that monitors the first monitoring indicator set, the prompt information indicating that the one or more indicators do not satisfy the preset conditions.

Optionally, the processor 12 may further execute program codes of the following steps: collecting a second monitoring indicator set returned by the TMS according to a preset cycle, the second monitoring indicator set including at least one of the following items: frequency of goods transportation information returned by the TMS, transportation damage rate of the TMS during transportation, and fault frequency of the TMS; and if one or more indicators in the second monitoring indicator set do not satisfy preset conditions, sending prompt information to a client that monitors the second monitoring indicator set, the prompt information indicating that the one or more indicators do not satisfy the preset conditions.

Optionally, the processor 12 may further execute program codes of the following steps: within a preset time range, acquiring first allocation data obtained when the TMS handles the allocation request and second allocation data obtained when the WMS handles the allocation request; and sending alarm information if the difference between the first allocation data and the second allocation data exceeds a preset value range, the alarm information prompting that the first allocation data and/or the second allocation data are abnormal.

The embodiments of the present disclosure provide a solution of handling an allocation request. Thus, by determining whether the TMS is instructed to coordinate with the WMS to handle the allocation request according to the response of the WMS to the allocation request, a situation that the TMS is instructed to coordinate with the WMS to handle the allocation request in the case in absence of the response of the WMS to the allocation request can be avoided by waiting for the response fed back by the WMS to the allocation request. The waste of TMS scheduling resources due to different responses of the TMS and the WMS to the allocation request can be avoided, thereby saving the TMS scheduling resources and improving the handover efficiency between the TMS and the WMS. Also, the following technical problem in the existing technology can be solved: the TMS is instructed to coordinate with the WMS to handle the allocation request when the handling result of the WMS to the allocation request is not acquired, causing waste of resources.

Those of ordinary skill in the art could understand that the structure shown in FIG. 9 is only schematic, and the computer terminal may also be terminal equipment such as a smart phone (e.g., an Android phone, an iOS phone, etc.), a tablet computer, a palm computer, a mobile internet device (MID), a PAD, etc. The structure of the above electronic device is not limited to FIG. 9. For example, the computer terminal may further include more or less components (e.g., a network interface, a display device, etc.) than those in FIG. 9, or has a configuration different from that shown in FIG. 9.

Those of ordinary skill in the art could understand that one or more of the steps in various methods of the above embodiments may be accomplished by a program instructing relevant hardware of the terminal equipment, the program may be stored in a non-transitory computer-readable storage medium, and the storage medium may include a flash disk, a read-only memory (ROM), a random access memory (RAM), a magnetic disk, an optical disk or the like.

The embodiment of the present disclosure further provides a storage medium. Optionally, in some embodiments, the storage medium may be configured to store program codes executed by the method for handling an allocation request provided by embodiment 1.

Optionally, in some embodiments, the storage medium may be located in any computer terminal of a computer terminal group in a computer network, or located in any mobile terminal of a mobile terminal group.

Optionally, in some embodiments, the storage medium is configured to store program codes for executing the following steps:

S1, issuing an allocation request to a WMS; and

S2, determining whether a TMS is instructed to coordinate with the WMS to handle the allocation request according to the response of the WMS to the allocation request.

The storage medium is further configured to store program codes for executing the following steps: when confirming that the WMS accepts the allocation request according to the response result, instructing the TMS to coordinate with the WMS to handle the allocation request; and when confirming that the WMS rejects the allocation request according to the response result, canceling the allocation request.

The storage medium is further configured to store program codes for executing the following steps: receiving an order allocation message fed back by the TMS according to the allocation request and corresponding to a transportation vehicle, the information carried in the order allocation message including identification information of the transportation vehicle and a transportation task undertaken by the transportation vehicle; and issuing a delivery voucher to the WMS according to the order allocation message, the delivery voucher instructing the WMS to allocate corresponding goods according to the transportation task and determining whether the goods are delivered to the transportation vehicle according to a verification information set. The verification information set at least includes the identification information of the transportation vehicle.

The storage medium is further configured to store program codes for executing the following steps: collecting a first monitoring indicator set returned by the WMS according to a preset cycle, the first monitoring indicator set including at least one of the following items: handling efficiency of the WMS on the allocation request, allocation efficiency of the WMS on goods, and fault frequency of the WMS; and if one or more indicators in the first monitoring indicator set do not satisfy preset conditions, sending prompt information to a client that monitors the first monitoring indicator set, the prompt information indicating that the one or more indicators do not satisfy the preset conditions.

The storage medium is further configured to store program codes for executing the following steps: collecting a second monitoring indicator set returned by the TMS according to a preset cycle, the second monitoring indicator set including at least one of the following items: frequency of goods transportation information returned by the TMS, transportation damage rate of the TMS during transportation, and fault frequency of the TMS; and if one or more indicators in the second monitoring indicator set do not satisfy preset conditions, sending prompt information to a client that monitors the second monitoring indicator set, the prompt information indicating that the one or more indicators do not satisfy the preset conditions.

The storage medium is further configured to store program codes for executing the following steps: within a preset time range, acquiring first allocation data obtained when the TMS handles the allocation request and second allocation data obtained when the WMS handles the allocation request; and sending alarm information if the difference between the first allocation data and the second allocation data exceeds a preset value range, the alarm information prompting that the first allocation data and/or the second allocation data are abnormal.

In the above embodiments of the present disclosure, the description of each embodiment has a focus, and for the part not specified in one embodiment, reference may be made to relevant description of other embodiments.

In the several embodiments provided by the present application, it shall be understood that the disclosed technical contents may be realized in other modes. Wherein, the above-described device embodiments are only exemplary, for example, the division of the units is only a logic function division, other division modes may be adopted in practice, e.g., a plurality of units or components may be combined or integrated in another system, or some features may be omitted or are not executed. From another point of view, the displayed or discussed mutual coupling or direct coupling or communication connection may be indirect coupling or communication connection of units or modules through some interfaces, and may also be in electrical or other forms.

The units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting one or more of the units according to actual needs.

In addition, in various embodiments of the present disclosure, the functional units may be integrated in one processing unit, or the function units may separately and physically exist, or two or more units may be integrated in one unit. The integrated unit may be realized in the form of hardware or in the form of software functional units.

When the integrated unit is realized in the form of software functional units and sold or used as an independent product, it may be stored in a computer-readable storage medium. Based on such an understanding, the technical solutions of the present disclosure substantially, or the part of the present disclosure making contribution to the prior art, or all of or part of the technical solutions may be embodied in the form of a software product, and the computer software product is stored in a storage medium, which includes a plurality of instructions enabling computer equipment (which may be a personal computer, a server, network equipment or the like) to execute one or more steps in the methods of the embodiments of the present disclosure. The aforementioned storage medium includes: various media capable of storing program codes, such as a U disk, a read-only memory (ROM), a random access memory (RAM), a mobile hard disk, a magnetic disk, an optical disk or the like.

Described above are preferred implementations of the present disclosure only. It should be pointed out that various improvements and modifications may also be made for those of ordinary skill in the art without departing from the principle of the present disclosure, and these improvements and modifications shall be deemed as falling within the protection scope of the present disclosure.

What is claimed is:

1. A method for handling an allocation request, comprising:
issuing an allocation request to a warehouse management system (WMS); and
instructing a transportation management system (TMS) to coordinate with the WMS to handle the allocation request, in response to determining that the WMS accepts the allocation request.

2. The method of claim 1, further comprising:
canceling the allocation request, in response to determining that the WMS rejects the allocation request according to the response result.

3. The method of claim 1, further comprising:
receiving an order allocation message fed back by the TMS according to the allocation request and corresponding to a transportation vehicle, wherein the order allocation message comprises identification information of the transportation vehicle and a transportation task undertaken by the transportation vehicle; and
issuing a delivery voucher to the WMS according to the order allocation message, wherein the delivery voucher instructs the WMS to allocate corresponding goods according to the transportation task and determines whether the goods are delivered to the transportation vehicle according to a verification information set, and the verification information set at least comprises the identification information of the transportation vehicle.

4. The method of claim 1, further comprising:
collecting a first monitoring indicator set returned by the WMS according to a preset cycle, wherein the first monitoring indicator set comprises at least one of the following items: handling efficiency of the WMS on the allocation request, allocation efficiency of the WMS on goods, and fault frequency of the WMS; and
in response to determining one or more indicators in the first monitoring indicator set do not satisfy preset conditions, sending prompt information to a client that monitors the first monitoring indicator set, the prompt information indicating that the one or more indicators do not satisfy the preset conditions.

5. The method of claim 1, further comprising:
collecting a second monitoring indicator set returned by the TMS according to a preset cycle, wherein the second monitoring indicator set comprises at least one of the following items: frequency of returning goods transportation information by the TMS, transportation damage rate of the TMS during transportation, and fault frequency of the TMS; and
in response to determining one or more indicators in the second monitoring indicator set do not satisfy preset conditions, sending prompt information to a client that monitors the second monitoring indicator set, the prompt information indicating that the one or more indicators do not satisfy the preset conditions.

6. The method of claim 1, further comprising:
within a preset time range, acquiring first allocation data obtained when the TMS handles the allocation request and second allocation data obtained when the WMS handles the allocation request; and
sending alarm information in response to determining a difference between the first allocation data and the second allocation data exceeds a preset value range, the alarm information prompting that at least one of the first allocation data or the second allocation data is abnormal.

7. A device for handling an allocation request, comprising:
a first issuing module configured to issue an allocation request to a warehouse management system (WMS); and
a handling module configured to instruct a transportation management system (TMS) to coordinate with the WMS to handle the allocation request, in response to determining that the WMS accepts the allocation request.

8. The device of claim 7, wherein the handling module is further configured to cancel the allocation request, in response to determining that the WMS rejects the allocation request.

9. The device of claim 7, wherein the device further comprises:
a receiving module configured to receive an order allocation message fed back by the TMS according to the allocation request and corresponding to a transportation vehicle, wherein the order allocation message comprises identification information of the transportation vehicle and a transportation task undertaken by the transportation vehicle; and
a second issuing module configured to issue a delivery voucher to the WMS according to the order allocation message, the delivery voucher instructing the WMS to allocate corresponding goods according to the transportation task and determining whether the goods are delivered to the transportation vehicle according to a verification information set, wherein the verification information set at least comprises the identification information of the transportation vehicle.

10. The device of claim 7, wherein the device further comprises:
a first collection module configured to collect a first monitoring indicator set returned by the WMS according to a preset cycle, wherein the first monitoring indicator set comprises at least one of the following items: handling efficiency of the WMS on the allocation request, allocation efficiency of the WMS on goods, and fault frequency of the WMS; and
a first monitoring module configured to, in response to determining one or more indicators in the first monitoring indicator set do not satisfy preset conditions, send prompt information to a client that monitors the first monitoring indicator set, the prompt information indicating that the one or more indicators do not satisfy the preset conditions.

11. The device of claim 7, wherein the device further comprises:
a second collection module configured to collect a second monitoring indicator set returned by the TMS according to a preset cycle, wherein the second monitoring indicator set comprises at least one of the following items: frequency of returning goods transportation information by the TMS, transportation damage rate of the TMS during transportation, and fault frequency of the TMS; and
a second monitoring module configured to, in response to determining one or more indicators in the second monitoring indicator set do not satisfy preset conditions, send prompt information to a client that monitors the second monitoring indicator set, the prompt information indicating that the one or more indicators do not satisfy the preset conditions.

12. The device of claim 7, wherein the device further comprises:
an acquisition module configured to, within a preset time range, acquire first allocation data obtained when the TMS handles the allocation request and second allocation data obtained when the WMS handles the allocation request; and
a control module configured to send alarm information in response to determining a difference between the first allocation data and the second allocation data exceeds a preset value range, the alarm information prompting that at least one of the first allocation data or the second allocation data is abnormal.

13. A non-transitory computer-readable storage media storing instructions that, when executed by a processor, cause the processor to perform a method for handling an allocation request, the method comprising:
issuing an allocation request to a warehouse management system (WMS); and
instructing a transportation management system (TMS) to coordinate with the WMS to handle the allocation request, in response to determining that the WMS accepts the allocation request.

14. The storage media of claim 13, wherein the method further comprises:
canceling the allocation request, in response to determining that the WMS rejects the allocation request according to the response result.

15. The storage media of claim 13, wherein the method further comprises:
receiving an order allocation message fed back by the TMS according to the allocation request and corresponding to a transportation vehicle, wherein the order allocation message comprises identification information of the transportation vehicle and a transportation task undertaken by the transportation vehicle; and
issuing a delivery voucher to the WMS according to the order allocation message, wherein the delivery voucher instructs the WMS to allocate corresponding goods according to the transportation task and determines whether the goods are delivered to the transportation vehicle according to a verification information set, and the verification information set at least comprises the identification information of the transportation vehicle.

16. The storage media of claim 13, wherein the method further comprises:
collecting a first monitoring indicator set returned by the WMS according to a preset cycle, wherein the first monitoring indicator set comprises at least one of the following items: handling efficiency of the WMS on the allocation request, allocation efficiency of the WMS on goods, and fault frequency of the WMS; and
in response to determining one or more indicators in the first monitoring indicator set do not satisfy preset conditions, sending prompt information to a client that monitors the first monitoring indicator set, the prompt information indicating that the one or more indicators do not satisfy the preset conditions.

17. The storage media of claim 13, wherein the method further comprises:
collecting a second monitoring indicator set returned by the TMS according to a preset cycle, wherein the second monitoring indicator set comprises at least one of the following items: frequency of returning goods transportation information by the TMS, transportation damage rate of the TMS during transportation, and fault frequency of the TMS; and
in response to determining one or more indicators in the second monitoring indicator set do not satisfy preset conditions, sending prompt information to a client that monitors the second monitoring indicator set, the prompt information indicating that the one or more indicators do not satisfy the preset conditions.

18. The storage media of claim 13, wherein the method further comprises:
within a preset time range, acquiring first allocation data obtained when the TMS handles the allocation request and second allocation data obtained when the WMS handles the allocation request; and
sending alarm information in response to determining a difference between the first allocation data and the second allocation data exceeds a preset value range, the alarm information prompting that at least one of the first allocation data or the second allocation data is abnormal.
